(19) United States
(12) Patent Application Publication
(10) Pub. No.: US 2014/0145673 A1
(43) Pub. Date: May 29, 2014

(54) System for Simultaneously Charging Multiple Portable Electronic Devices

(71) Applicant: Joseph Heilbrun, Monroe, NY (US)

(72) Inventor: Joseph Heilbrun, Monroe, NY (US)

(21) Appl. No.: 14/093,146

(22) Filed: Nov. 29, 2013

Related U.S. Application Data
(60) Provisional application No. 61/731,305, filed on Nov. 29, 2012.

(51) Int. Cl. H02J 7/00

(52) U.S. Cl. CPC H02J 7/0042
USPC 320/107

(57) ABSTRACT

A system for simultaneously charging the multiple portable electronic devices is used to serially recharge a number of electronic devices without having to use more than one electrical outlet. The system also allows these electronic devices to more evenly distribute electrically power amongst the coupled group of devices. The multiple portable electronic devices can be coupled to send and receive electrical power by a plurality of charging conduits, which can be retractable plugs, power cables, or induction coils.

The current application claims a priority to the U.S. Provisional Patent application Ser. No. 61/731,305 filed on Nov. 29, 2012.

### FIELD OF THE INVENTION

The present invention relates generally to a charging system. More specifically, the present invention allows multiple portable electronic devices to serially couple and exchange their electric power with each other.

### BACKGROUND OF THE INVENTION

Electronic devices have become a mainstay in the modern world. These electronic devices are relied upon for communication, life and work organization, and entertainment. It is quite common for people to own and use more than one electronic device as part of their daily lives. Electronic devices such as mobile phones, laptops, tablet computers, and Bluetooth earpieces require charging after use. Recharging multiple electronic devices and accessories quickly becomes a hassle, particularly in situations where the number of available power sources is limited. The present invention seeks to provide a means of minimizing the number of power sources required. In its preferred embodiment, the present invention is intended for use with multiple types and instances of electronic devices. The present invention allows a virtually limitless number of electronic devices to be interconnected and simultaneously charged while minimizing the required external power sources. The present invention also allows the communal electrical power amongst the interconnected electronic devices to be more evenly distributed amongst the devices, instead of charging through an electrical outlet.

### BRIEF DESCRIPTION OF THE DRAWINGS

FIG. 1 is a front perspective view of the system components as actual portable electronic devices.

FIG. 2 is a block diagram for the overall system of the present invention.

FIG. 3 is a block diagram depicting the source portable electronic device drawing power from an electrical outlet.

FIG. 4 is a block diagram depicting the source device as the portable electronic device with the most battery life.

FIG. 5 is a block diagram depicting the present invention with retractable plugs as the charging conduits, wherein the retractable plugs are in a withdrawn state.

FIG. 6 is a block diagram depicting the present invention with retractable plugs as the charging conduits, wherein the retractable plugs are in an extruded and engaged state.

FIG. 7 is a front perspective view of portable electronic devices with retractable plugs as the charging conduits.

FIG. 8 is a back perspective view of a single portable electronic device with its retractable plug in the extruded state.

FIG. 9 is a back perspective view of the single portable electronic device with its retractable plug in the withdrawn state.

FIG. 10 is a block diagram depicting the present invention with power cables as the charging conduits

FIG. 11 is a perspective view of portable electronic devices with power cables as the charging conduits.

FIG. 12 is a block diagram depicting the present invention with induction coils as the charging conduits

FIG. 13 is a perspective view of portable electronic devices with induction coils as the charging conduits, wherein the portable electronic devices are stacked upon each other in order to utilize the induction coils.

### DETAILED DESCRIPTIONS OF THE INVENTION

All illustrations of the drawings are for the purpose of describing selected versions of the present invention and are not intended to limit the scope of the present invention.

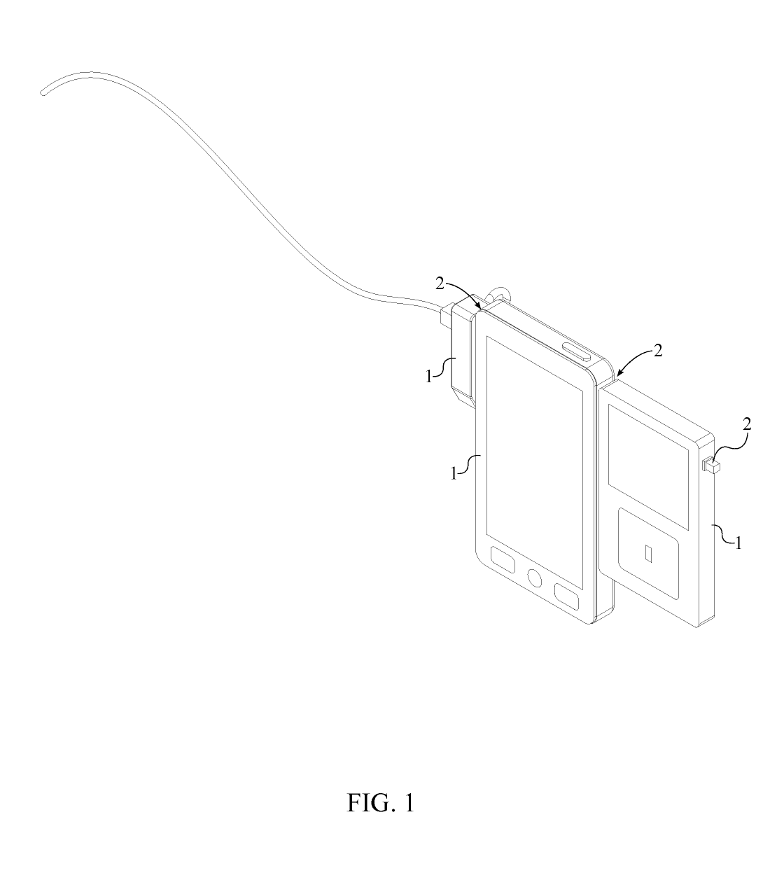

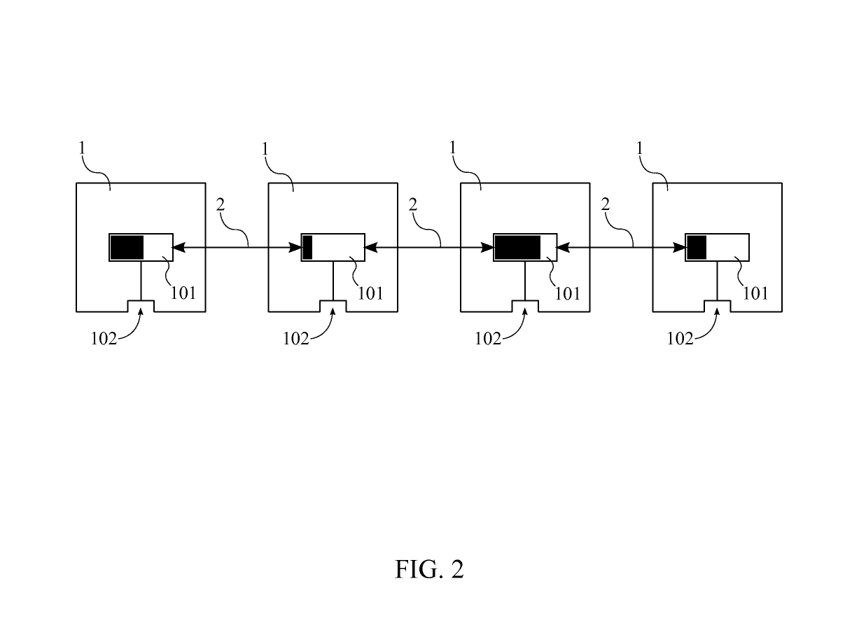

As can be seen in FIG. 1, the present invention is a system for simultaneously charging multiple portable electronic devices. The present invention can be used to reduce the external power sources that are required to charge multiple portable electronic devices. For example, one power outlet can be used to charge to two or more devices instead of just one device. The present invention can also be used to more evenly distribute the collective power amongst multiple portable electronic devices. For example, a device at half power would share its power amongst devices at nearly zero power. Thus, the present invention comprises a plurality of portable electronic devices (PEDs) and a plurality of charging conduits 2, which are shown in FIG. 2. Each of the plurality of PEDs 1 can be, but is not limited to, a mobile phone, a laptop, a tablet personal computer, or a Bluetooth earpiece. The present invention allows a virtually limitless number of PEDs and accessories to be electrically interconnected for charging. In addition, each of the plurality of PEDs 1 comprises a rechargeable battery 101 and a charging socket 102, which are electrically connected to each other within each PED. The rechargeable battery 101 is the means of storing electrical power for each PED. The charging socket 102 allows the rechargeable battery 101 to send and receive external electrical power. The plurality of charging conduits 2 is used to transfer electrical power from one PED to another PED within the present invention. Thus, the rechargeable battery 101 for each of the plurality of PEDs 1 is serially and electrically coupled to each other by the plurality of charging conduits 2.

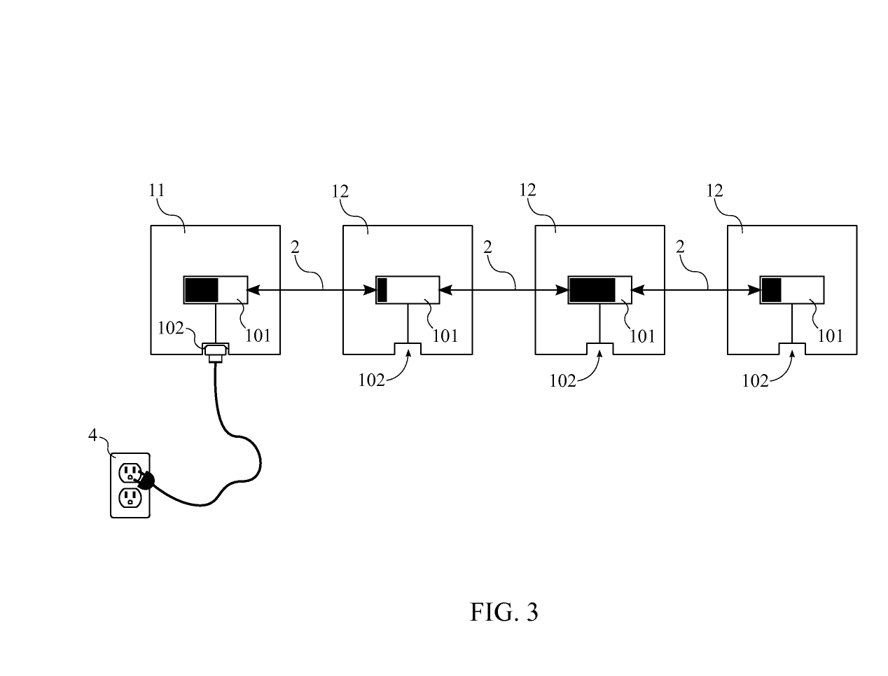

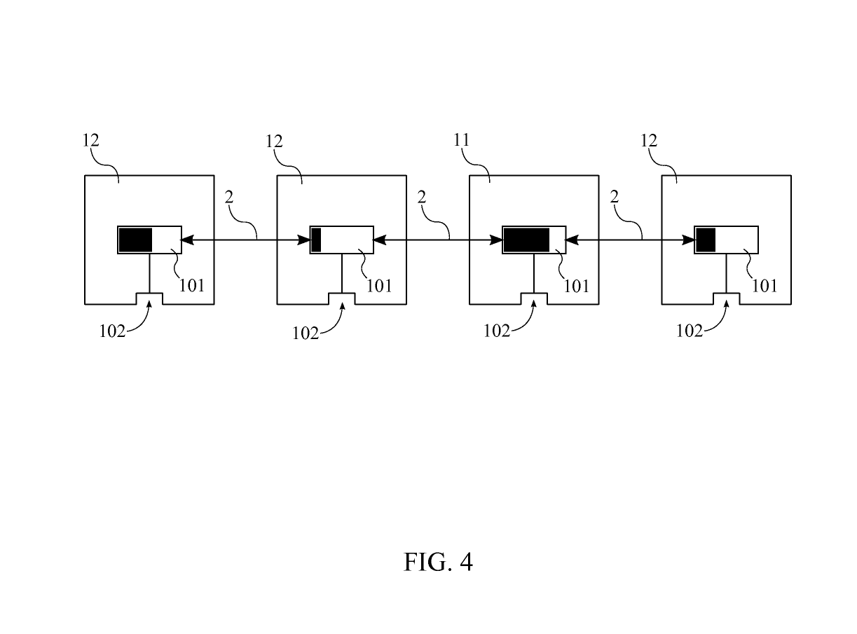

The present invention utilizes an at least one source PED 11 within the plurality of PEDs 1, which is used to electrically charge other PEDs 12 within the plurality of PEDs 1. There are two methods to designate the source PED 11 amongst the plurality of PEDs 1. As can be seen in FIG. 3, one method is to electrically connect the rechargeable battery 101 of the source PED 11 to a power outlet 4 through its charging socket 102. Thus, the present invention allows the other PEDs 12 to be electrically charged through the power outlet 4 and the source PED 11. In some instances, more than one PED can be electrically connected to a power outlet 4, which allows the present invention to have more than one source PED 11. As can be seen in FIG. 4, another method is for the rechargeable battery 101 of the source PED 11 to have more stored power than the rechargeable battery 101 for each of the other PEDs 12, which is a method that occurs when none of the PEDs are electrically connected to a power outlet 4. Thus, the present invention allows the other PEDs 12 to retrieve the stored electrical power from the source PED 11. In some instances, the more than one PED have significantly more stored power than the other PEDs 12, which allows the present invention to have more than one source PED 11. In one embodiment of the present invention, an indicator light can be used to display the charging status for each of the plurality of PEDs 1. The indicator light could display an alternate color to inform a user that charging is in progress for a PED or to inform the user that charging is complete for a PED.

In the preferred embodiment of the present invention, a software application may be utilized in conjunction with the charging conduits of the plurality of PEDs 1. The software application is capable of managing various aspects of the present invention. These aspects include, but are not limited to, regulating preset charge times, enabling/disabling charge capability, and automatic powering-off of devices after charging has completed. Additionally, the software application can be used to designate the at least one source PED 11, or, in other words, a user can select which PEDs will distribute their power to the other PEDs 12. In an alternative embodiment, the user may regulate the charging capability of the present invention by means of a switch located on each of the plurality of PEDs 1.

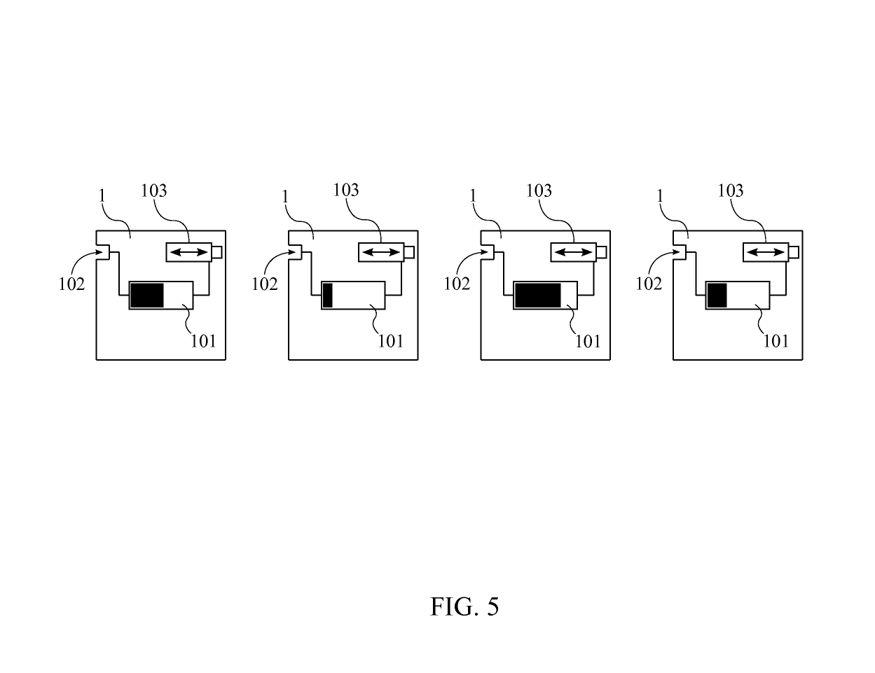

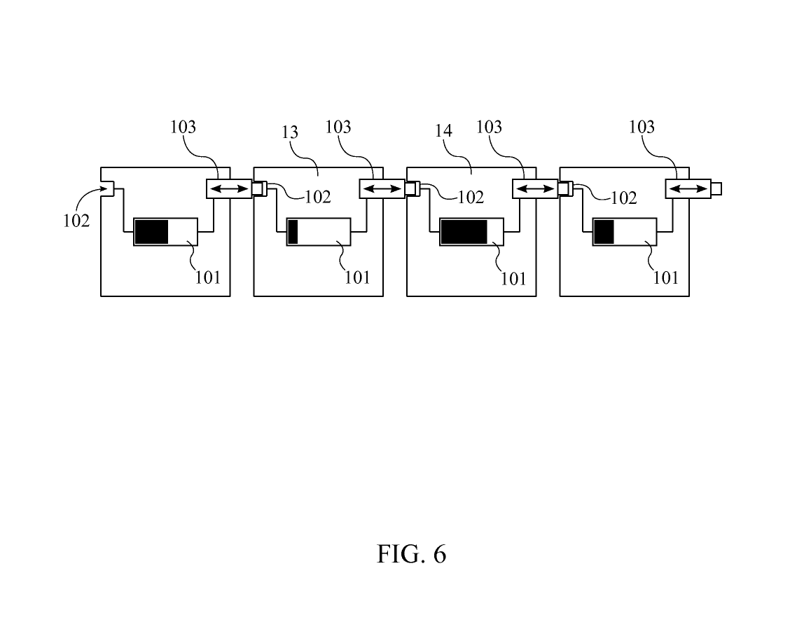

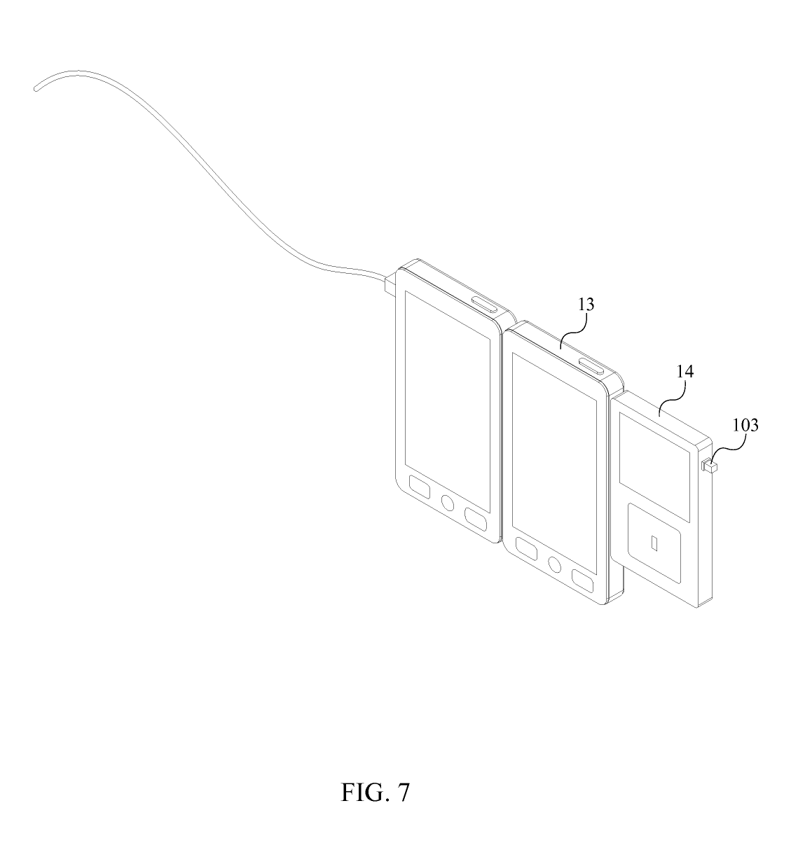

In one embodiment of the present invention, the plurality of charging conduits 2 is designed to rigidly couple the plurality of PEDs 1 together, which is illustrated in FIG. 7. In this embodiment, each of the plurality of PEDs 1 further comprises a retractable plug 103, which is shown in FIG. 5. The retractable plug 103 can be selectively protruded from its PED by either a mechanical switch or an electronic switch. This selective feature allows the retractable plug 103 to maintain a low profile on the aesthetic appearance of each PED. The retractable plug 103 and the charging socket 102 may be of any form including, but not limited to, Universal Serial Bus (USB) and 3.5 mm. In order to maintain universal compatibility of the present invention and to further increase versatility, adapters may be utilized to achieve compatibility between normally incompatible couplings. As can be seen FIG. 6, the retractable plug 103 is used to send and receive electrical power from another PED. Consequently, the retractable plug 103 is electrically connected to the rechargeable battery 101 for each of the plurality of PEDs 1. When the retractable plug 103 of an arbitrary PED 13 is in its outward position, the retractable plug 103 of the arbitrary PED 13 can be engaged to the charging socket 102 of an adjacent PED 14. The arbitrary PED 13 and the adjacent PED 14 are used to represent any two adjacent PEDs within the plurality of PEDs 1. In this embodiment of the present invention, the retractable plug 103 of the arbitrary PED 13 and the charging socket 102 of the adjacent PED 14 form a charging conduit between the rechargeable battery 101 of the arbitrary PED 13 and the rechargeable battery 101 of the adjacent PED 14.

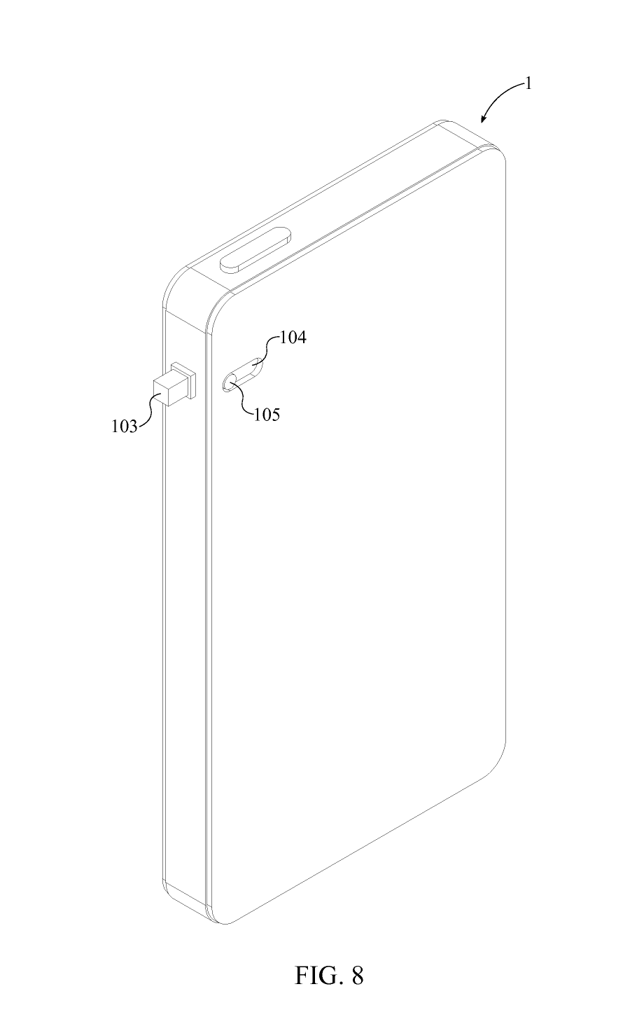

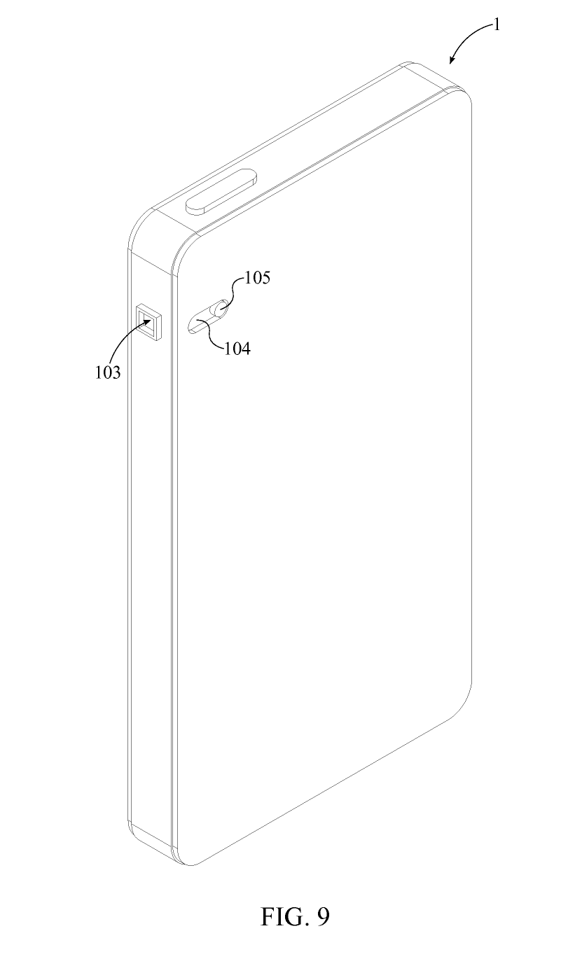

A specific configuration for the retractable plug 103 includes an embedded track 104 and a push tab 105 for each of the plurality of PEDs 1, which are shown in FIGS. 8 and 9. The embedded track 104 is used to guide the movement of the retractable plug 103, and, thus, the retractable plug 103 is slidably engaged to the embedded track 104. In addition, the embedded track 104 is built into the housing of each PED so that the embedded track 104 does not become obtrusive while holding the PED. The push tab 105 allows a user to apply a mechanical force to extrude and withdraw the retractable plug 103 from its PED. The push tab 105 is connected onto the retractable plug 103 and is perpendicularly positioned to the embedded track 104 so that the mechanical force provided by the user moves the retractable plug 103 along the embedded track 104.

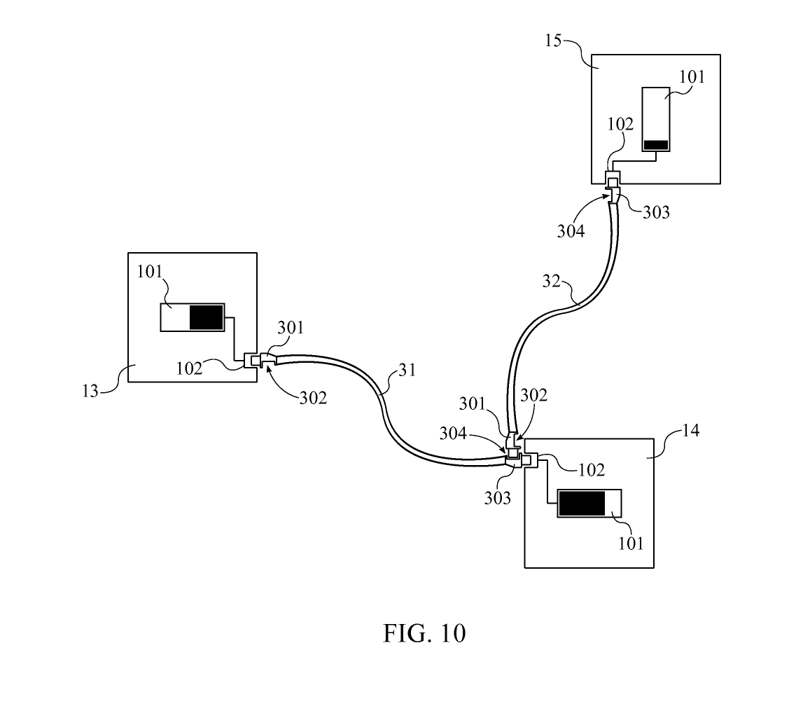

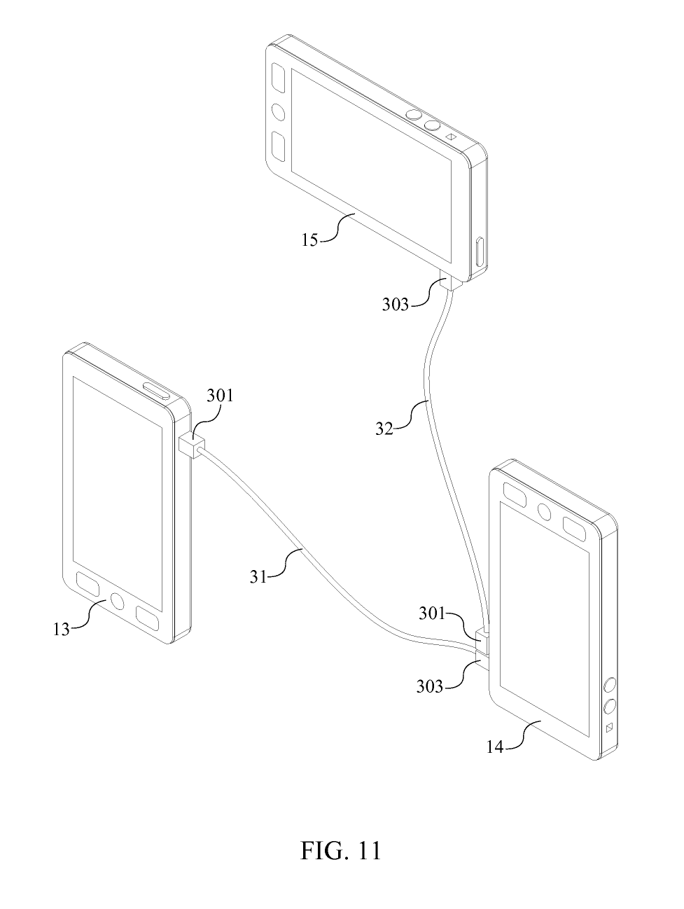

In another embodiment of the present invention, the plurality of charging conduits 2 is designed to tether the plurality of PEDs 1 together. In this embodiment, a power cable 31 is located in between an arbitrary PED 13 and an adjacent PED 14, which is shown in FIG. 11. The arbitrary PED 13 and the adjacent PED 14 are used to represent any two adjacent PEDs within the plurality of PEDs 1. As can be seen in FIG. 10, the power cable 31 comprises a first end 301, a first forking socket 302, a second end 303, and a second forking socket 304. In order to transfer power between two adjacent PEDs, the first end 301 of the power cable 31 has to be engaged to the charging socket 102 of the arbitrary PED 13, and a second end 303 of the power cable 31 is engaged to the charging socket 102 of the adjacent PED 14. The first end 301 and the second end 303 of the power cable 31 are male connectors that are capable of securely fastening either end of the power cable 31 to the charging socket 102. The ends of the power cable 31 and the charging socket 102 may be of any form including, but not limited to, Universal Serial Bus (USB) and 3.5 mm. In order to maintain universal compatibility of the present invention and to further increase versatility, adapters may be utilized to achieve compatibility between normally incompatible couplings. The ends of the power cable 31 may also include a power switch, which would allow a user to choose when to transfer electrical power from the arbitrary PED 13 to the adjacent PED 14. In this embodiment of the present invention, the power cable 31 forms a charging conduit between the rechargeable battery 101 of the first PED and the rechargeable battery 101 of the second PED.

As can be seen in FIG. 10, the first forking socket 302 and the second forking socket 304 are used to branch power into and out of the power cable 31, which allows the present invention to electrically interconnect the plurality of PEDs 1. One method to branch out power from the power cable 31 is to engage the first end 301 of another power cable 32 to either the first forking socket 302 or the second forking socket 304 of the power cable 31, which allows power traveling through the power cable 31 to flow into the other power cable 32. In addition, the second end 303 of the other power cable 32 needs to be engaged to the charging socket 102 of an additional PED 15, which allows power to flow into the additional PED 15. The additional PED 15 can be any PED within the plurality of PEDs 1 other than the designated arbitrary PED 13 and the designated adjacent PED 14. In this embodiment, the other power cable 32 forms an additional charging conduit between the power cable 31 and the rechargeable battery 101 of the additional PED 15. Another method to branch power into the power cable 31 is to electrically connect the power cable 31 to a power outlet 4 through either the first forking socket 302 or the second forking socket 304. Thus, the first forking socket 302 and the second forking socket 304 are necessary because the charging socket 102 of each PED is occupied by either a first end 301 or a second end 303 of some power cable 31, which prevents any PED within the present invention from directly receiving power from a power outlet 4.

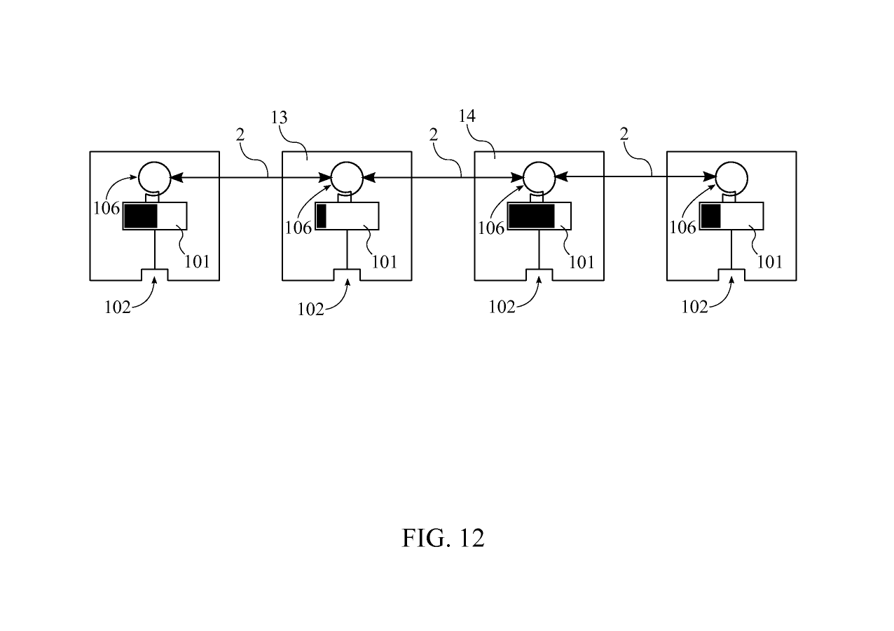

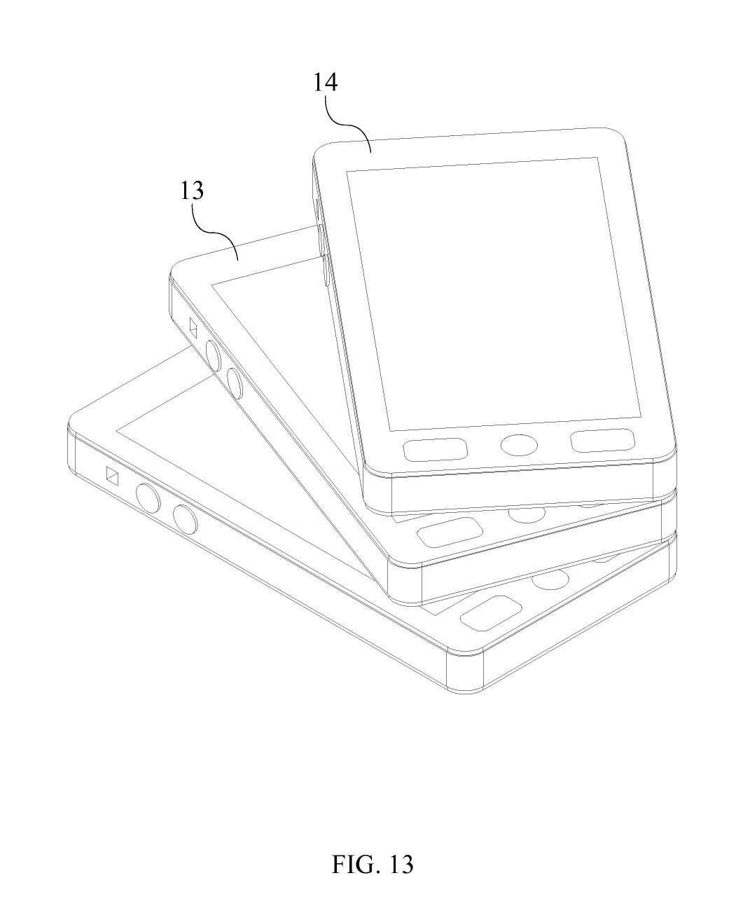

In another embodiment of the present invention, the plurality of charging conduits 2 is designed to link the plurality of PEDs 1 while allowing them to freely move around. In this embodiment, the present invention wirelessly charges the plurality of PEDs 1, and, thus, each of the plurality of PEDs 1 comprises an induction coil 106, which is shown in FIG. 12. In order to utilize inductive charging, an arbitrary PED 13 needs to be positioned onto an adjacent PED 14, which is illustrated in FIG. 13. Again, the arbitrary PED 13 and the adjacent PED 14 are used to represent any two adjacent PEDs within the plurality of PEDs 1. Once the arbitrary PED 13 and the adjacent PED 14 are within close proximity, the induction coil 106 of the arbitrary PED 13 will inductively couple to the induction coil 106 of the adjacent PED 14. This allows the rechargeable battery 101 of the arbitrary PED 13 and the rechargeable battery 101 of the adjacent PED 14 to wireles sly exchange electrical power by converting an electrical current into an electromagnetic field and vice versa. In this embodiment of the present invention, the induction coil 106 of the arbitrary PED 13 and the induction coil 106 of the adjacent PED 14 form a charging conduit between the rechargeable battery 101 of the arbitrary PED 13 and the rechargeable battery 101 of the adjacent PED 14.

It is understood that the present invention relates generally to all electronic devices and external electronic accessories that are capable of charging. Electronic devices generally encompass mobile phones, laptops, tablet computers, portable music players, and Bluetooth accessories. Furthermore, the charging conduits of the present invention may be located in various other positions and take on embodiments that differ from the preferred embodiment previously described.

Although the invention has been explained in relation to its preferred embodiment, it is to be understood that many other possible modifications and variations can be made without departing from the spirit and scope of the invention as hereinafter claimed.

What is claimed is:

1. A system for simultaneously charging multiple portable electronic devices comprises:
a plurality of portable electronic devices (PEDs);
said plurality of PEDs includes an at least one source PED and other PEDs;
each of said plurality of PEDs comprises a rechargeable battery and a charging socket;
said rechargeable battery being electrically connected to said standard charging socket for each of said plurality of PEDs; and
said rechargeable battery for each of said plurality of PEDs being serially and electrically coupled to each other by a plurality of charging conduits.

2. The system for simultaneously charging multiple portable electronic devices as claimed in claim 1 comprises:
said rechargeable battery of an at least one source PED being electrically connected to a power outlet through said charging socket.

3. The system for simultaneously charging multiple portable electronic devices as claimed in claim 1 comprises:
said rechargeable battery of an at least one source PED having more stored electrical power than said rechargeable battery of each of other PEDs.

4. The system for simultaneously charging multiple portable electronic devices as claimed in claim 1 comprises:
each of the plurality of PEDs further comprises a retractable plug;
said retractable plug and said charging socket being positioned opposite to each other for each of said plurality of PEDs;
said retractable plug being electrically connected to said rechargeable battery for each of said plurality of PEDs;
said retractable plug of an arbitrary PED selectively protruding from said arbitrary PED, wherein said plurality of PEDs includes said arbitrary PED and an adjacent PED;
said retractable plug of said arbitrary PED being engaged to said charging socket of an adjacent PED; and
said retractable plug of said arbitrary PED and said plug socket of said adjacent PED forming a charging conduit between said rechargeable battery of said arbitrary PED and said rechargeable battery of said adjacent PED.

5. The system for simultaneously charging multiple portable electronic devices as claimed in claim 1 comprises:
each of the plurality of PEDs further comprises an embedded track and a push tab;
said retractable plug being slidably engaged within said embedded track;
said push tab being connected onto said retractable plug; and
said push tab being perpendicularly positioned to said embedded track.

6. The system for simultaneously charging multiple portable electronic devices as claimed in claim 1 comprises:
a power cable being located between an arbitrary PED and an adjacent PED, wherein said plurality of PEDs includes said arbitrary PED and said adjacent PED;
said power cable comprises a first connector, a first forking socket, a second end, and a second forking end;
said first end of said power cable being engaged to said charging socket of said first PED;
said second end of said power cable being engaged to said charging socket of said second PED; and
said power cable forming a charging conduit between said rechargeable battery of said first PED and said rechargeable battery of said second PED.

7. The system for simultaneously charging multiple portable electronic devices as claimed in claim 6 comprises:
a first end of another power cable being engaged to said first forking socket of said power cable;
a second end of said other power cable being engaged to said charging socket of an additional PED, wherein said plurality of PEDs includes said additional PED; and
said other power cable forming an additional charging conduit between said power cable and said rechargeable battery of said additional PED.

8. The system for simultaneously charging multiple portable electronic devices as claimed in claim 6 comprises:
a first end of another power cable being engaged to said second forking socket of said power cable;
a second end of said other power cable being engaged to said charging socket of an additional PED, wherein said plurality of PEDs includes said additional PED; and
said other power cable forming an additional charging conduit between said power cable and said rechargeable battery of said additional PED.

9. The system for simultaneously charging multiple portable electronic devices as claimed in claim 6 comprises:
said power cable being electrically connected to a power outlet through said first forking socket.

10. The system for simultaneously charging multiple portable electronic devices as claimed in claim 6 comprises:
said power cable being electrically connected to a power outlet through said second forking socket.

11. The system for simultaneously charging multiple portable electronic devices as claimed in claim 1 comprises:
each of said plurality of PEDs comprises an induction coil;
said induction coil being electrically connected to said rechargeable battery for each of said plurality of PEDs;
an arbitrary PED being positioned onto an adjacent PED, wherein said plurality of PEDs includes said arbitrary PED and said adjacent PED;
said induction coil of said arbitrary PED being inductively coupled to said induction coil of said adjacent PED; and
said induction coil of said arbitrary PED and said induction coil of said adjacent PED forming a charging conduit between said rechargeable battery of said arbitrary PED and said rechargeable battery of said adjacent PED.

12. A system for simultaneously charging multiple portable electronic devices comprises:
a plurality of portable electronic devices (PEDs);
said plurality of PEDs includes an at least one source PED and other PEDs;
each of said plurality of PEDs comprises a rechargeable battery and a charging socket;
said rechargeable battery being electrically connected to said standard charging socket for each of said plurality of PEDs;
said rechargeable battery for each of said plurality of PEDs being serially and electrically coupled to each other by a plurality of charging conduits;
each of the plurality of PEDs further comprises a retractable plug;
said retractable plug and said charging socket being positioned opposite to each other for each of said plurality of PEDs;
said retractable plug being electrically connected to said rechargeable battery for each of said plurality of PEDs;
said retractable plug of an arbitrary PED selectively protruding from said arbitrary PED, wherein said plurality of PEDs includes said arbitrary PED and an adjacent PED;
said retractable plug of said arbitrary PED being engaged to said charging socket of an adjacent PED; and
said retractable plug of said arbitrary PED and said plug socket of said adjacent PED forming a charging conduit between said rechargeable battery of said arbitrary PED and said rechargeable battery of said adjacent PED.

13. The system for simultaneously charging multiple portable electronic devices as claimed in claim 12 comprises:
said rechargeable battery of an at least one source PED being electrically connected to a power outlet through said charging socket.

14. The system for simultaneously charging multiple portable electronic devices as claimed in claim 12 comprises:
said rechargeable battery of an at least one source PED having more stored electrical power than said rechargeable battery of each of other PEDs.

15. The system for simultaneously charging multiple portable electronic devices as claimed in claim 12 comprises:
each of the plurality of PEDs further comprises an embedded track and a push tab;
said retractable plug being slidably engaged within said embedded track;
said push tab being connected onto said retractable plug; and
said push tab being perpendicularly positioned to said embedded track.

16. A system for simultaneously charging multiple portable electronic devices comprises:
a plurality of portable electronic devices (PEDs);
said plurality of PEDs includes an at least one source PED and other PEDs;
each of said plurality of PEDs comprises a rechargeable battery and a charging socket;
said rechargeable battery being electrically connected to said standard charging socket for each of said plurality of PEDs;
said rechargeable battery for each of said plurality of PEDs being serially and electrically coupled to each other by a plurality of charging conduits;
a power cable being located between an arbitrary PED and an adjacent PED, wherein said plurality of PEDs includes said arbitrary PED and said adjacent PED;
said power cable comprises a first connector, a first forking socket, a second end, and a second forking end;
said first end of said power cable being engaged to said charging socket of said first PED;
said second end of said power cable being engaged to said charging socket of said second PED; and
said power cable forming a charging conduit between said rechargeable battery of said first PED and said rechargeable battery of said second PED.

17. The system for simultaneously charging multiple portable electronic devices as claimed in claim 16 comprises:
said rechargeable battery of an at least one source PED being electrically connected to a power outlet through said charging socket.

18. The system for simultaneously charging multiple portable electronic devices as claimed in claim 16 comprises:
said rechargeable battery of an at least one source PED having more stored electrical power than said rechargeable battery of each of other PEDs.

19. The system for simultaneously charging multiple portable electronic devices as claimed in claim 16 comprises:
a first end of another power cable being engaged to said first forking socket of said power cable;
a second end of said other power cable being engaged to said charging socket of an additional PED, wherein said plurality of PEDs includes said additional PED; and
said other power cable forming an additional charging conduit between said power cable and said rechargeable battery of said additional PED.

20. The system for simultaneously charging multiple portable electronic devices as claimed in claim 16 comprises:
a first end of another power cable being engaged to said second forking socket of said power cable;
a second end of said other power cable being engaged to said charging socket of an additional PED, wherein said plurality of PEDs includes said additional PED; and
said other power cable forming an additional charging conduit between said power cable and said rechargeable battery of said additional PED.
